(19) United States
(12) Patent Application Publication
(10) Pub. No.: US 2008/0030593 A1
(43) Pub. Date: Feb. 7, 2008

(54) CONTINUAL-IMAGE PROCESSING DEVICE

(75) Inventor: Koichi SATO, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/867,382

(22) Filed: Oct. 4, 2007

Related U.S. Application Data
(63) Continuation of application No. 09/824,248, filed on Apr. 3, 2001, now abandoned.

(30) Foreign Application Priority Data
Apr. 7, 2000 (JP) 2000106074

(51) Int. Cl. H04N 5/225

(52) U.S. Cl. 348/220.1; 348/E05.024; 348/E05.047

(57) ABSTRACT

An electronic still camera includes a memory, a determination processor and an image processor. The memory stores a discrete image obtained in a still photographing operation and, for each such image sequentially obtained in a continual still image photographing operation in which discrete images are taken at an interval time set by an operator, stores a unique indicator indicating whether the discrete image was sequentially recorded in the continual still image photographing operation. The determination processor determines whether the discrete images were obtained in the continual still image photographing operation. The image processor continually reproduces the discrete images at the interval of the continual still image photographing operation, when the discrete images were obtained in the continual still image photographing operation. The determination processor determines whether the discrete images were obtained in the continual still image photographing operation by reading image recording information recorded for each of the discrete images.

### CROSS-REFERENCE TO RELATED APPLICATION

This continuation application is continuation application of pending U.S. patent application Ser. No. 09/824,248, which was filed on Apr. 3, 2001, which claims the benefit of Japanese Patent Application No. 2000-106074, filed on Apr. 7, 2000, the contents of which are expressly incorporated by reference herein in their entirety.

### BACKGROUND OF THE INVENTION

1. Field of the Invention

The present invention relates to an electronic still camera able to perform a continual photographing operation, and more particularly to a device provided in the electronic still camera to perform an image processing of a plurality of images obtained in the continual photographing operation.

2. Description of the Related Art

An electronic still camera is usually provided with a monitor device, such as a liquid crystal display, which can display an image obtained as a photograph. Conventionally, there is known an electronic still camera able to perform a continual photographing operation. Images, obtained in the continual photographing operation, can be displayed by the monitor device in a way similar to those obtained in a normal photographing operation or by a single shot.

The monitor device provided in the conventional electronic still camera is configured in such a manner that a single image is displayed at every operation of a control switch, regardless of whether the displayed image has been obtained in a continual photographing operation or by a single shot. Accordingly, an effect of the continual photographing operation is not easily recognized by the operator. Further, when an image obtained by the continual photographing operation is deleted, the control switch must be operated for each and every image, which is cumbersome.

### SUMMARY OF THE INVENTION

Therefore, an object of the present invention is to provide an continual-image processing device in which, when an image obtained in a continual photographing operation is reproduced or deleted, the reproducing or deleting operation is simplified.

According to the present invention, there is provided a continual-image processing device comprising a continual-image determination processor and an image processor. The continual-image determination processor determines whether a plurality of images are obtained in a continual photographing operation. The image processor continually performs a common operation on the plurality of images when it is determined by the continual-image determination processor that the plurality of images are obtained in the continual photographing operation.

Furthermore, according to the present invention, there is provided a continual-image processing device comprising a continually recording processor that continually records a plurality of images at a predetermined interval, and an image processor that continually performs a common operation on the plurality of images.

### BRIEF DESCRIPTION OF THE DRAWINGS

The objects and advantages of the present invention will be better understood from the following description, with reference to the accompanying drawings in which:

FIG. 1 is a perspective view of an electronic still camera viewed from the back, the camera being provided with a continual-image processing device of a first embodiment of the present invention;

FIG. 2 is a block diagram of the electronic still camera, which shows mainly an electrical construction;

FIGS. 3A, 3B and 3C show a flow chart of a photographing operation control routine;

FIG. 4 is a view showing examples of a continual-image flag;

FIG. 5 is a flow chart of a reproducing process control routine of a second embodiment; and

FIG. 6 is a flow chart of a reproducing operation control routine of a third embodiment.

### DESCRIPTION OF THE PREFERRED EMBODIMENTS

The present invention will be described below with reference to the embodiments shown in the drawings.

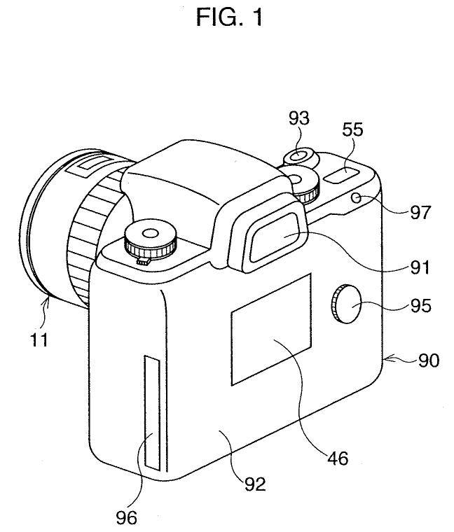

FIG. 1 is a perspective view of an electronic still camera viewed from the back, the camera having a continual-image processing device of a first embodiment of the present invention.

The electronic still camera is a single-lens reflex camera, and an interchangeable lens 11, which is the photographing optical system, is detachably connected to the camera body 90. An optical viewfinder 91 is provided on the center of the upper surface of the camera body 90. A liquid crystal display panel 46 is provided at the center of the rear surface of the camera body 90. Thus, a moving image obtained by the interchangeable lens 11, and a still image corresponding to image data stored in a memory (not shown) by a photographing operation, can be displayed on the liquid crystal panel 46. A mode switch 95 is disposed beside the liquid crystal display panel 46. The mode switch 95 is provided for setting various kinds of operation modes, and is a jog dial in the embodiment.

When viewing the camera body 90 from the upper side of the rear surface 92, a shutter button 93, a condition indicating device 55 and a reproduction start/stop switch 97 are provided on an upper-right portion of the camera body 90. The condition indicating device 55 includes a liquid crystal display panel, by which various kinds of setting conditions of the electronic still camera are indicated by characters or symbols. The reproduction start/stop switch 97 is operated for starting and stopping the reproducing of an image on the liquid crystal display panel 46. For example, when the reproduction start/stop switch 97 is set to a mode of the reproduction start switch, the mode is changed to the reproduction stop switch by depressing the reproduction start/stop switch 97 for a time longer than a predetermined period, and vice versa.

A card slot 96 is formed in a side surface of the camera body 90. The card slot 96 is provided for inserting a PC or memory card into the camera body 90, and a card connector (not shown), to which the PC card is attached, is provided within the card slot 96.

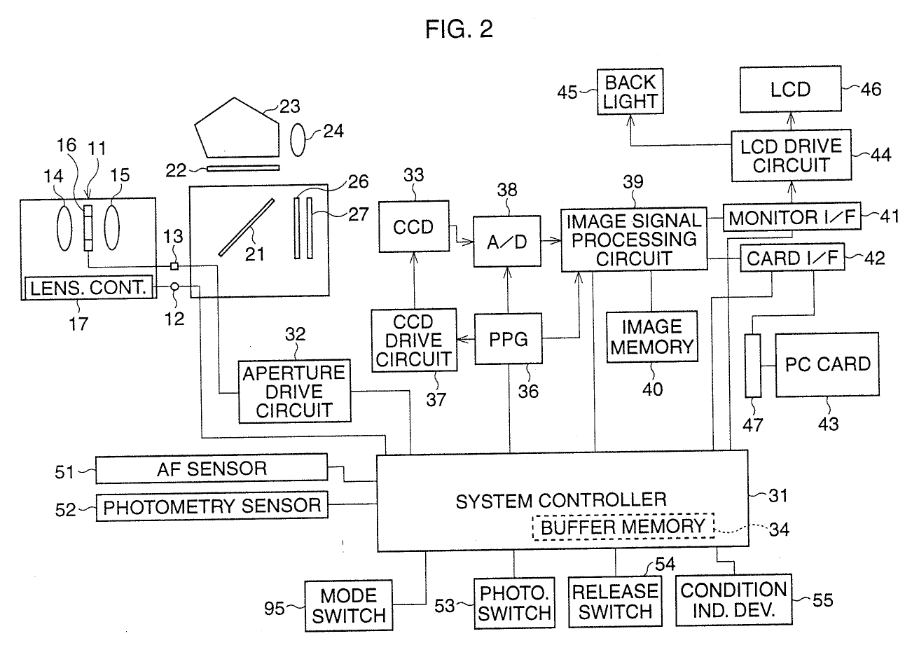

FIG. 2 is a block diagram of the electronic still camera, showing mainly an electrical construction.

The interchangeable lens 11 is electrically connected to an electric circuit provided in the camera body 90 (see FIG. 1) through mount pins 12 and 13. A front lens group 14 and a rear lens group 15 are mounted in a lens barrel of the interchangeable lens 11, and an aperture 16 is provided between the lens groups 14 and 15. Each of the lens-groups 14 and 15 is displaced in the optical axis direction under the control of a lens control circuit 17, so that a focusing operation can be carried out. The lens control circuit 17 is operated in accordance with a control signal transmitted through the mount pin 12 from the system controller 31 provided in the camera body. The aperture 16 is operated in accordance with a control signal transmitted through the mount pin 13 from an aperture drive circuit 32 provided in the camera body, so that the degree of opening of the aperture 16 can be adjusted. The operation of the aperture drive circuit 32 is controlled by the system controller 31.

In the camera body 90, a half-mirror 21 is disposed on the optical axis of the lens groups 14 and 15. The half-mirror 21 is fixed at a position inclined by approximately 45 degrees relative to the optical axis of the lens groups 14 and 15. A focusing glass 22 is provided above the half-mirror 21 and a pentagonal prism 23 is arranged above the focusing glass 22. An eyepiece lens 24 of a viewfinder is disposed behind the pentagonal prism 23. Therefore, light passing through the lens groups 14 and 15 is reflected by the half-mirror 21 and lead onto the pentagonal prism 23, and thus the object image can be observed through the eyepiece 24.

An infrared cut filter 26 and an optical low-pass filter 27 are arranged behind the half-mirror 21. A CCD (i.e., an imaging device) 33 is provided behind the optical low-pass filter 27. Therefore, light passing through the lens groups 14 and 15 is transmitted through the half-mirror 21 and the filters 26 and 27, and is radiated onto a light receiving surface of the CCD 33. Namely, the image obtained through the lens groups 14 and 15 is formed on the light receiving surface, and thus, an image signal corresponding to the object image is generated in the CCD 33.

A pulse pattern generator (PPG) 36 is connected to the system controller 31 and generates various kinds of pulse signals under control of the system controller 31. Based on these pulse signals, the CCD drive circuit 37, an A/D converter 38 and an image signal processing circuit 39 are driven. The operation of the CCD 33 is controlled by the CCD drive circuit 37. Namely, the image signal read from the CCD 33 is converted to digital image data by the A/D converter 38, and is then subjected to a predetermined process by the image signal processing circuit 39. An image memory 40, having a capacity large enough to store frames of digital image data, is connected to the image signal processing circuit 39.

A monitor interface 41 and a card interface 42 are connected to the image signal processing circuit 39. These interfaces 41 and 42 are controlled by the system controller 31. Aback light 45 and the liquid crystal display panel (LCD) 46 are connected to the monitor interface 41 through a liquid crystal display drive circuit 44. Control of the liquid crystal display drive circuit 44 is based on the image signal read from the CCD 33, so that a moving image obtained by the interchangeable lens 11 is displayed on the liquid crystal panel 46, as described above. Alternatively, based on the image data transmitted to a buffer memory (not shown) from the PC card 43, the liquid crystal display drive circuit 44 is controlled so that a still image is displayed by the liquid crystal display panel 46. A card connector 47 is connected to the card interface 42, and a PC card 43 is attached to the card connector 47.

An AF sensor 51 and a photometry sensor 52 are connected to the system controller 31. The AF sensor 51 has a known construction, by which the focusing condition of the lens groups 14 and 15 is sensed. A photometry is performed using the photometry sensor 52, so that the degree of opening of the aperture 16 for the exposure and an electric charge accumulation period (i.e., an exposure period) of the CCD 33 are determined.

The photometry switch 53, the release switch 54 and the condition indicating device 55 are connected to the system controller 31. The photometry switch 53 is turned ON by partly depressing the shutter button 93 so that a photometric operation is carried out by the photometry sensor 52. The release switch 54 is turned ON by fully depressing the shutter button 93, so that the CCD 33 is exposed, and thus an image signal corresponding to the object image is generated in the CCD 33.

The mode switch 95 is connected to the system controller 31. The mode switch 95 is a jog dial as described above, which is rotated and set to a position corresponding to an operation mode, and is depressed while maintaining the set position, so that the operation mode is determined. The operation mode includes a continual photographing mode, in which a plurality of images are recorded at a predetermined interval.

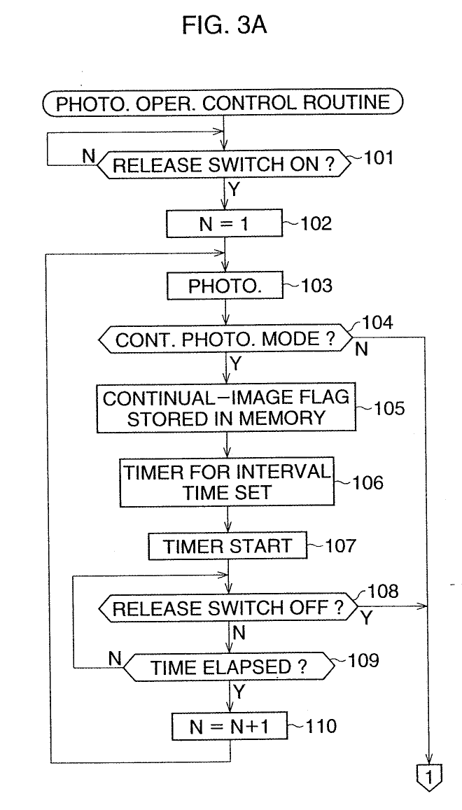

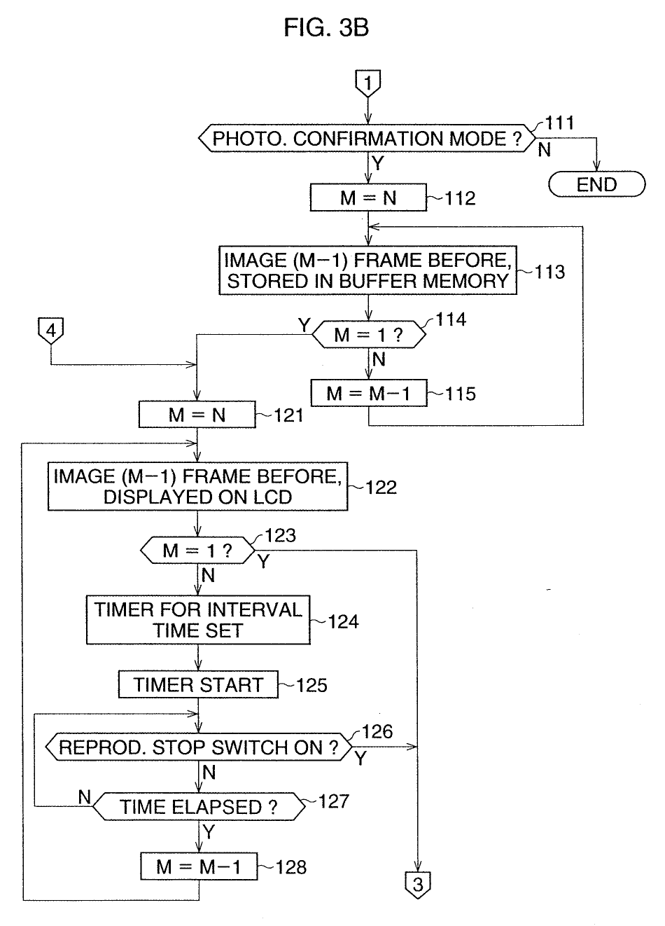

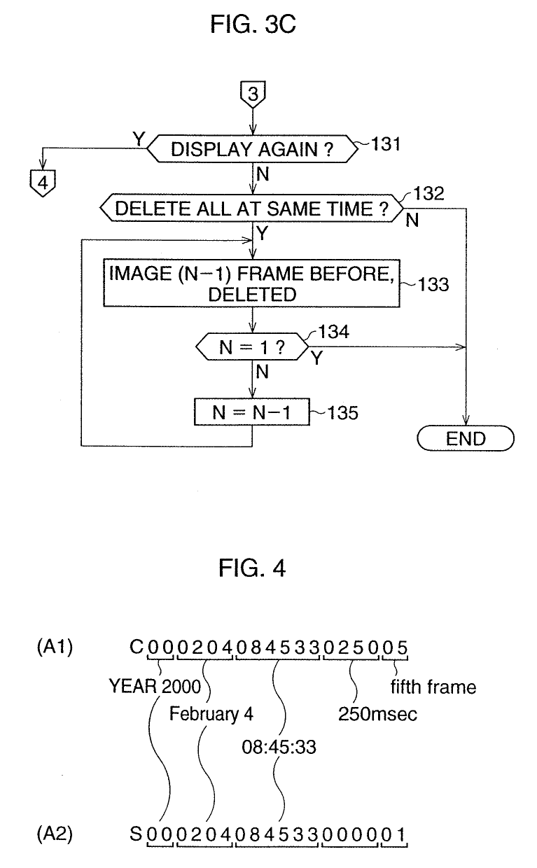

FIGS. 3A, 3B and 3C show a flow chart of a photographing operation control routine, which is a program for carrying out a photographing operation. The recording operation control routine is executed in the system controller 31.

In Step 101, it is determined whether the release switch 54 is turned ON. When the release switch 54 is turned OFF, Step 101 is repeatedly executed, and when the release switch 54 is turned ON, the process goes to Step 102, in which a counter N indicating the number of photographed images is set to an initial value “1”. In Step 103, a photographing operation is performed. Namely, an electronic shutter is performed in the CCD 33 to generate an image signal, which is read from the CCD 33, converted to digital data, and stored in the memory 40.
In Step 104, it is determined whether a continual photographing mode is set. The continual photographing mode is set by operating the mode switch 95. When the continual photographing mode is set, the process goes to Step 105, and when the continual photographing mode is not set, the process goes to Step 111.

In Step 105, a continual-image flag is stored in a header area of the memory 40, which corresponds to an image record area in which the image data is stored. In Step 106, a timer for checking an interval time, which is a period between each of the photographing operations in the continual photographing operation, is set. The interval time is 0.2 sec, for example, and is set by operating the mode switch 95. In Step 107, the timer is initiated to start a clock operation.

In Step 108, it is determined whether the release switch is in the OFF state. When the release switch is not in the OFF state, Step 109 is executed, in which it is determined whether a predetermined time has elapsed since the timer started in Step 107, i.e., it is determined whether the interval time, set in Step 106, has elapsed. When the predetermined time has not elapsed, the process goes back to Step 108. Namely, while the release switch is in the ON state and the predetermined time has not elapsed, Steps 108 and 109 are repeatedly executed. Conversely, when the predetermined time has elapsed, Step 110 is executed in which 1 is added to the counter N, and the process goes back to Step 103, so that the operations described above are again performed. For example, when the interval time is 0.2 sec, Step 103 is executed every 0.2 sec to carry out a photographing operation for as long as the release switch is in the ON state.

When it is determined in Step 104 that the continual photographing mode is not set, or when it is determined in Step 108 that the release switch is changed to the OFF state, Step 111 is executed in which it is determined whether a photographing confirmation mode is set. In the photographing confirmation mode, an image is displayed on the liquid crystal display panel 46 based on the image data obtained in the photographing operation performed in Step 103. The photographing confirmation mode is set by operating the mode switch 95. When the photographing confirmation mode is not set, the program ends. Conversely, when the photographing confirmation mode is set, the process goes to Step 112.

In Step 112, a value of the counter N indicating the number of photographed images is set as the initial value to a counter M, which corresponds to an image displayed on the liquid crystal panel 46. In Step 113, image data of a first recorded image, which is separated by (M−1) frames from the last image corresponding to the counter N set at that time, and the continual-image flag, are read from the memory 40, and stored in a buffer memory 34 provided in the system controller 31. For example, when a continual photographing operation is performed to obtain 10 frames of images, the counter N is 10 and the counter M is set to 10 by the execution of Step 112, and therefore, image data of the image recorded nine frames previously, i.e., the first frame image, and the continual-image flag, are stored in the buffer memory 34.

In Step 114, it is determined whether the counter M is 1. In Step 115, 1 is subtracted from the counter M, and Step 113 again executed. Namely, image data of the image, which is one frame next to the image stored in the buffer memory 34 by the previous execution of Step 113, and the continual-image flag, are stored in an area of the buffer memory 34 adjacent to an area stored by the previous execution of Step 113. Due to the execution of the loop composed of Steps 113, 114 and 115, when a storing operation to the buffer memory 34 is completed for the last frame image included in a plurality of images obtained by the continual photographing operation, it is determined in Step 114 that the counter M is 1, and the process goes to Step 121.

In Step 121, a value of the counter N indicating the number of photographed images is set as the initial value to the counter M. In Step 122, an image, which is positioned (M−1) frames before an image of the last frame corresponding to the counter N, which is set at that time, is displayed on the liquid crystal display panel 46. For example, when 10 frames of images are obtained by a continual photographing operation, the first frame image is displayed on the liquid crystal display panel 46 when Step 122 is executed for the first time.

In Step 123, it is determined whether the counter M is 1. When the counter M has not reached 1, the process goes to Step 124, in which a timer for checking an interval time of a continual displaying operation corresponding to the interval time of the continual photographing operation is set. The interval time is recognized by reading the continual-image flag, as described later. In Step 125, the timer is initiated to start a clock operation.

In Step 126, it is determined whether the reproduction stop switch 97 is in the ON state. When the reproduction stop switch 97 is not in the ON state, Step 127 is executed, in which it is determined whether a predetermined time has elapsed since the timer started in Step 125. When the predetermined time has not elapsed, the process goes back to Step 126. Namely, while the reproduction stop switch 97 is in the OFF state and the predetermined time has not elapsed, Steps 126 and 127 are repeatedly executed. Conversely, when the predetermined time has elapsed, Step 128 is executed, in which 1 is subtracted from the counter M, and the process goes back to Step 122, so that the operations described above are again performed. For example, when the interval time is 0.2 sec, Step 122 is executed every 0.2 sec so that the images, obtained by the continual photographing operation, are displayed one frame by one frame for as long as the reproduction stop switch 97 is in the OFF state. Thus, due to the execution of the loop composed of Steps 122 through 128, the images are displayed on the liquid crystal display panel 46 at the same interval time and in the same order as in the continual photographing operation.

When it is determined in Step 123 that the counter M is 1, or when it is determined in Step 126 that the reproduction stop switch 97 is in the ON state, Step 131 is executed in which a message or icon meaning “Should the images obtained by the continual photographing operation be displayed again ?” is displayed on the liquid crystal display panel 46. When the reproduction start switch 97 is in the ON state, the process goes back to Step 121, so that the operations described above are executed to display again the images obtained by the continual photographing operation. Conversely, when the reproduction start switch 97 is not in the ON state, the process goes from Step 131 to Step 132.

In Step 132, a message or icon meaning “Should all the images obtained by the continual photographing operation be deleted ?” is displayed on the liquid crystal display panel 46. The deleting operation is carried out by setting and depressing the mode switch 95, for example. When all the images obtained by the continual photographing operation are to be deleted, Step 133 is executed in which image data of an image recorded by (N−1) frames before the last image corresponding to the counter N set at that time, and the continual-image flag, are deleted from the memory 40. In Step 134, it is determined whether the counter N is 1. When the counter has not reached 1, 1 is subtracted from the counter N in Step 135, and Step 133 is then executed. When it is determined in Step 132 that the deletion is not performed, or when it is confirmed in Step 134 that the counter N has reached 1, the program ends.

As the continual-image flag, various forms can be adopted. FIG. 4 shows examples of the continual-image flag. Reference A1 depicts an example of a continual photographing operation and reference A2 depicts an example of a single shot.

In each example, data “C” of the most significant bit means the continual photographing operation, and data “S” of the most significant bit means the single shot. “00” of the second and third significant bits mean that the photography was carried out in the year 2000. The fourth through seventh significant bits mean that the date of photography was February 4 (i.e., 02/04), and the eighth through thirteenth significant bits mean that the time of photography was 8:45:33. Note that the time of photography in the example A1 is that of the first frame. Namely, “084533” is a time at which the first image is taken or photographed in a continual photographing operation. The fourteenth through seventeenth significant bits mean that the interval time of the continual photographing operation is 250 msec in the first example A1. These are set to “0000” in the second example A2, since there is no interval time. The two least significant bits indicate the fifth frame of the continual photographing operation in the first example A1, and are set to “01” in the second example A2.

According to the embodiment as described above, when the continual photographing operation is performed, Steps 122 through 128 are executed, so that the images are displayed on the liquid crystal display panel 46 at the same interval time and in the same order as in the continual photographing operation. Therefore, the movement or change of the object in the continual photographing operation can be observed at the liquid crystal display panel 46. Further, according to the embodiment, since the image data obtained by the continual photographing operation are continuously and smoothly deleted, the deleting operation can be carried out easily and quickly, in comparison with an operation of a conventional device in which image data is deleted one frame by one frame while confirming the image.

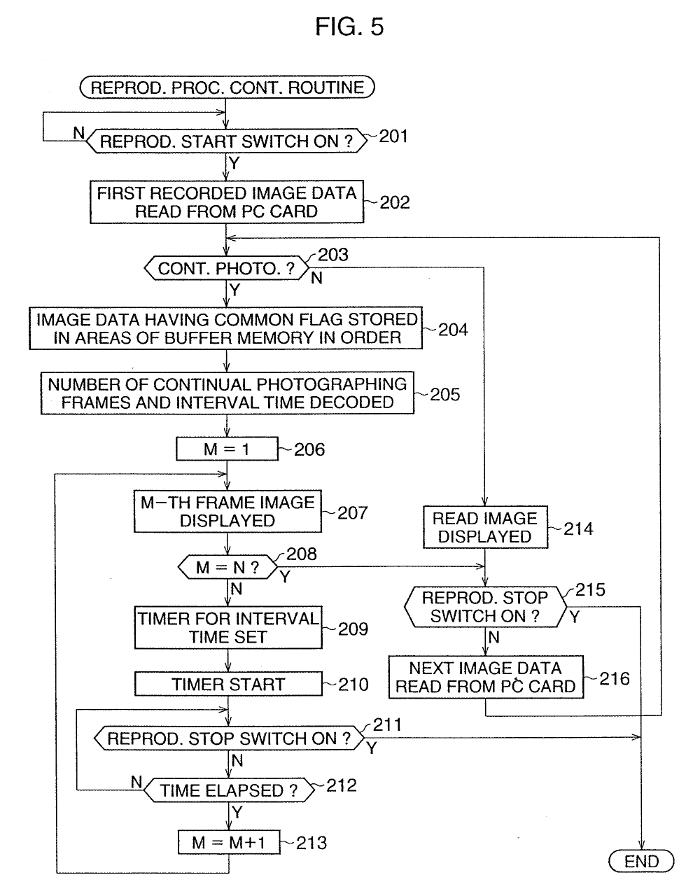

FIG. 5 is a flow chart of a reproducing process control routine of a second embodiment. In the second embodiment, the mechanical and electrical configurations of the electronic still camera are the same as those shown in FIGS. 1 and 2. Although the photographing operation executed ahead of the reproducing process in the second embodiment is the same as shown in Steps 101 through 110 (FIG. 3A) of the first embodiment, image data and continual-image flag are recorded in the PC card 43 in the second embodiment.

In Step 201, it is determined whether the reproduction start switch 97 is in the ON state. When it is confirmed that the reproduction start switch 97 is in the ON state, Step 202 is executed in which image data, which was recorded first, and the continual-image flag corresponding to the image data, are read from the PC card 43. In Step 203, the content of the continual-image flag is decoded, and it is determined whether the corresponding image data was obtained by a continual photographing operation. The continual-image flag is the same as that shown in FIG. 4, and based on the data of the most significant bit, it is determined whether the image data was obtained by a continual photographing operation. When it is determined that the image data was obtained by the continual photographing operation, Step 204 is executed, and when the image data was obtained by a single shot, Step 214 is executed.

In Step 204, image data, having a continual-image flag common to the image data read in Step 202, is stored in a predetermined area of the buffer memory 34 in an order in which the photographing operations were performed. The term common continual-image flag means a continual-image flag in which data from the most significant bit through the thirteenth bit in FIG. 4, i.e., the date and time of photography, are identical. In Step 205, based on data of the six least significant bits of the continual-image flag, the number of continual photographing frames N and the interval time are decoded. In Step 206, the initial value 1 is set to the counter M.

In Step 207, an image of the M-th frame stored in the buffer memory 34 is displayed on the liquid crystal display panel 46. In step 208, it is determined whether the counter M is equal to the number of continual photographing frames N. When the counter M is not equal to the number of continual photographing frames N, i.e., when a series of images obtained by the continual photographing operation have not been displayed yet, the process goes to Step 209. Namely, a timer for checking the interval time in the continual displaying operation corresponding to the interval time of the continual photographing operation is set. In Step 210, the timer is initiated to start a clock operation.

In Step 211, it is determined whether the reproduction stop switch 97 is in the ON state. When the reproduction stop switch 97 is not in the ON state, Step 212 is executed, in which it is determined whether a predetermined time has elapsed since the timer started in Step 210. When the predetermined time has not elapsed, the process goes back to Step 211. Namely, while the reproduction stop switch 97 is in the OFF state and the predetermined time has not elapsed, Steps 211 and 212 are repeatedly executed. Conversely, when the predetermined time has elapsed, Step 213 is executed in which 1 is added to the counter M, and the process goes back to Step 207, so that the operations described above are again performed. For example, when the interval time is 0.2 sec, Step 207 is executed every 0.2 sec so that the images, obtained by the continual photographing operation, are displayed one frame by one frame (at an interval of 0.2 sec), as long as the reproduction stop switch 97 is in the OFF state. Thus, due to the execution of the loop composed of Steps 207 through 213, the images are displayed on the liquid crystal display panel 46 at the same interval time and in the same order as in the continual photographing operation.

When it is determined in Step 208 that the counter M is equal to the number of continual photographing frames N, the process goes to Step 215, the contents of which will be described later. When it is determined in Step 211 that the reproduction start switch 97 is in the ON state, the program ends.

When it is determined in Step 203 that the image data was not obtained by a continual photographing operation, the process goes to Step 214, in which an image is displayed on the liquid crystal display unit 46 based on the image data read from the PC card 43. In Step 215, it is determined whether the reproduction stop switch 97 is in the ON state. When the reproduction stop switch 97 is in the ON state, the program ends.

When it is determined in Step 215 that the reproduction stop switch 97 is not in the ON state, the process goes to Step 216, in which the next image data is read from the PC card 43, and the process then goes back to Step 203. Thus, Step 204 is executed regarding the next image data, and Steps 204 through 213 or Steps 214 through 216 are executed in accordance with the continual-image flag.

As described above, in the second embodiment, when the PC card 43 is mounted in the electronic still camera and the reproduction start switch 97 is then depressed, the contents of the PC card 43 are automatically read. Then, when image data obtained by a continual photographing operation area read, the images are displayed at the same interval for example, 0.2 sec, as in the continual photographing operation. Therefore, according to the embodiment, any change of movement of the object of the continual photographing operation can be observed.

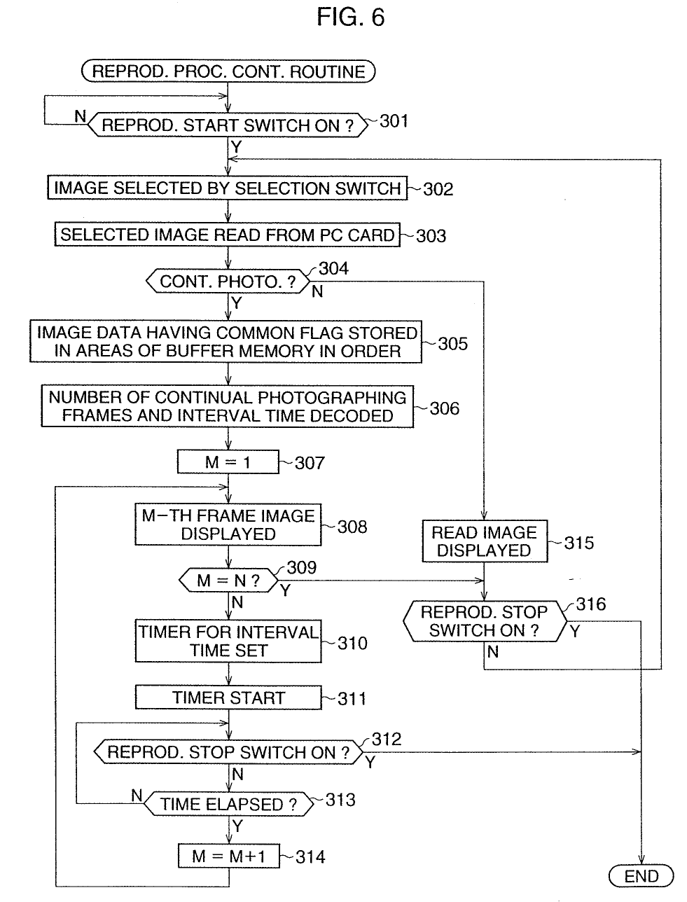

FIG. 6 is a flow chart of a reproducing process control routine of a third embodiment. In the third embodiment, the mechanical and electrical configurations of the electronic still camera are the same as those shown in FIGS. 1 and 2. Similar to the second embodiment, the photographing operation executed ahead of the reproducing process in the third embodiment is the same as shown in Steps 101 through 110 (FIG. 3A) of the first embodiment, and image data and the continual-image flag are recorded in the PC card 43.

In Step 301, it is determined whether the reproduction start switch 97 is in the ON state. When it is confirmed that the reproduction start switch 97 is in the ON state, Step 302 is executed in which, using a selection button, an image or a frame number is selected. The mode switch (or the jog dial) 95 functions as the selection button when set at a predetermined rotation position. In Step 303, the image data, corresponding to the image selected in Step 302, and the continual-image flag, are read from the PC card 43. In Step 304, the content of the continual-image flag is decoded in a similar way to Step 203 shown in FIG. 5, so that it is determined whether the corresponding image data was obtained by a continual photographing operation. When it is determined that the corresponding image data was obtained by the continual photographing operation, Step 305 is executed, and when the image data was obtained by a single shot, Step 315 is executed.

The contents of Steps 305 through 314 are the same as those of Steps 204 through 213 shown in FIG. 5, and an explanation thereof is omitted.

The contents of Steps 315 and 316 are the same as those of Steps 214 and 215 shown in FIG. 5, but, after the execution of Step 316, the process goes back to Step 302.

As described above, in the third embodiment, it is determined whether the selected image was obtained by a continual photographing operation or by a single shot, and thus the reproducing operation is performed in accordance with the continual-image flag. Accordingly, in the third embodiment, the operation of reproducing the desired image is carried out first, and a series of images obtained by a continual photographing operation can be continually displayed.

Note that, although the present invention is applied to an electronic still camera in each of the above embodiments, the present invention can be applied to an image processing device such as a computer.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2000-106074 (filed on Apr. 7, 2000) which is expressly incorporated herein, by reference, in its entirety.

1. An electronic still camera comprising:
a memory that stores a discrete image obtained in a still photographing operation, and that stores, for each of a plurality of discrete images sequentially obtained in a continual still image photographing operation in which the plurality of discrete images are taken at an interval time set by an operator, a unique indicator that indicates whether the discrete image was sequentially recorded in the continual still image photographing operation;
a determination processor that determines whether the plurality of discrete images were obtained in the continual still image photographing operation; and
an image processor that continually reproduces the plurality of discrete images, as a common operation on the plurality of discrete images, at a same interval as that of the continual still image photographing operation, when it is determined, using the unique indicator, that the plurality of discrete images were obtained in the continual still image photographing operation,
wherein the determination processor determines whether the plurality of discrete images were obtained in the continual still image photographing operation by reading image recording information recorded for each of the plurality of discrete images.

2. The electronic still camera of claim 1, wherein the image processor continually reproduces the plurality of discrete images as the common operation.

3. The electronic still camera of claim 1,
wherein the image processor continually deletes the plurality of discrete images as the common operation.

4. The electronic still camera of claim 1,
wherein the image recording information comprises a continual-image flag recorded in a header area corresponding to an image recording area in which a discrete image is recorded.

5. An electronic still camera, comprising:
a recording processor that continually records a plurality of discrete images at a predetermined interval set by an operator in a continual still image photographing operation in which the plurality of discrete images are taken; and
a memory that stores, for each of the plurality of discrete images, a unique indicator that indicates whether the discrete image was sequentially recorded in the continual still image photographing operation,
wherein the unique indicator enables the plurality of discrete images to be continually displayed as discrete images at a same interval as that of the continual still image photographing operation, and
wherein the determination processor determines whether the plurality of discrete images were obtained in the continual still image photographing operation by reading image recording information recorded for each of the plurality of discrete images.

6. The electronic still camera of claim 5, further comprising:
an image processor that continually performs a common operation on the plurality of discrete images.
